(19) United States
(12) Patent Application Publication
(10) Pub. No.: US 2017/0264009 A1
(43) Pub. Date: Sep. 14, 2017

(54) REDUCED MOISTURE PERMEABLE RADOMES AND ENCLOSURES AND METHODS OF MAKING SAME

(71) Applicant: Raytheon Company, Waltham, MA (US)

(72) Inventor: Karl L. Worthen, Dallas, TX (US)

(21) Appl. No.: 15/331,284

(22) Filed: Oct. 21, 2016

Related U.S. Application Data
(60) Provisional application No. 62/307,754, filed on Mar. 14, 2016.

(51) Int. Cl. H01Q 1/42

(52) U.S. Cl. CPC H01Q 1/42

(57) ABSTRACT

A radome includes a first layer through which electromagnetic radiation is transmittable. The radome also includes a moisture barrier layer connected to the second layer, the moisture barrier layer being formed of a single sheet of polychlorotrifluoroethene or a liquid crystal polymer.

### DOMESTIC PRIORITY

This application is a non-provisional of and claims priority to U.S. Application Ser. No. 62/307,754, entitled “REDUCED MOISTURE PERMEABLE RADOMES AND ENCLOSURES AND METHODS OF MAKING SAME”, filed on Mar. 14, 2016, which is incorporated herein by reference in its entirety.

### BACKGROUND

The present invention relates to a radomes and, more specifically, to a high performance moisture resistant radomes and methods of forming the same.

A large number of radar systems require an enclosure to provide environmental protection to the electronic apertures. An example of such an enclosure is a radome. Such radomes are sometimes designed and optimized to have high performance characteristics in that they provide for minimum radio frequency (RF) loss, are ruggedized for environmental protection and are relatively light weight with little regard to low cost. These radomes can be designed for commercial and/or military applications and can be optimized for different frequency bands of the electromagnetic spectrum. In addition, radomes sometimes need to be resistant to and sealed against moisture, chemicals, gases and dust, plus be able to withstand wide temperature ranges and have a required color. It is often needed that designers sacrifice low cost to meet all these other requirements.

High performance radomes require careful selection and understanding of material properties that directly affect radome and antenna performance. The combination of high performance requirements and a requirement for low cost create a problem where a solution is not intuitively obvious. For instance, conventional A-sandwich and C-sandwich radome constructions are common ways to have low RF loss, low weight and high strength but are not considered low cost designs. An A-sandwich radome has two high dielectric skins (sheets) and a low dielectric core, whereas a C-sandwich radome has three high dielectric skins and two low dielectric cores. A conventional A-sandwich or C-sandwich radome construction utilizes specialty materials, requires a cure cycle, and is usually an autoclave operation. They are typically designed with multiple types of materials and uncommon thicknesses of materials, using a radome facility with an autoclave and highly trained personnel for assembly.

Composite enclosures and radomes have inherently high moisture transmission rates making them unsuitable for applications containing moisture sensitive components. Coating methods such as atomic layer deposition (ALD) and chemical vapor deposition (CVD) require separate expensive, size limiting equipment. Using sheet stock films require several pieces and seams to seal structure. It is not very effective due to the high transmission rate of the seams. Metal deposition to seal a composite is limited to applications that do not require RF transparency and are subject to corrosion and cracking.

### SUMMARY

According to one embodiment of the present invention, a radome is disclosed. The radome includes a first layer through which electromagnetic radiation is transmittable and a moisture barrier layer connected to the second layer. The moisture barrier is formed of a single sheet of polychlorotrifluoroethene or a liquid crystal polymer.

According to another embodiment, a method of providing a moisture barrier to a radome is disclosed. The method includes: forming the radome; forming the moisture barrier layer as a single sheet of polychlorotrifluoroethene or a liquid crystal polymer; and coupling the radome and the moisture barrier layer together.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a side schematic illustration of a radome in accordance with embodiments;

FIG. 2 is a side schematic illustration of a barrier layer formed on a tool in accordance with further embodiments;

FIG. 3A-FIG. 3B show a side schematic illustration of a radome with a barrier layer being formed by injection molding in accordance with further embodiments;

FIG. 4 is a side schematic illustration of a radome formed over a barrier layer in accordance with further alternative embodiments; and

FIG. 5 is a side schematic illustration of a barrier layer formed over a radome in accordance with further alternative embodiments.

### DETAILED DESCRIPTION

As will be described below, an enclosure is provided that low cost processes to allow for the formation of an inclusion of a moisture barrier therein. Herein, the description will focus on radomes but it shall be understood that the teachings herein may be applied to any type of permeable enclosure by the skilled artisan after reading this disclosure.

The moisture barrier is a net shape single piece film that can be bonded to the radome, injected into or onto the radome, preformed and then the radome is formed over it or the film may thermoformed directly on the radome. One embodiment may reduce the moisture permeability of composite enclosures and radomes by several orders of magnitude so that they can be used for moisture sensitive components by eliminating seams.

The barrier may be formed by incorporating a net shape single piece of low moisture permeation films formed of polychlorotrifluoroethene (PCTFE or PTFCE (e.g., Aclar)) or a liquid crystal polymer (LCP) into the enclosure or radome. This may eliminate most/all seams associated with present film sealing methods and the net shape films can be bonded to complex shapes. Indeed, direct formation and bonding of the film onto/into the enclosure or radome will be possible for many applications and may be done with the same or similar tooling used to make radome or enclosure, thus removing size limitations of ALD/CVD.

Using a net shape one piece films enables complex shapes, greater array of product, and eliminates the issues with seams and may improve performance compared to adhesively bonding sheets and slices. Using a net shape one piece films provide the ability to incorporate the liner in-situ and solves bonding issues and removes adhesive layer.

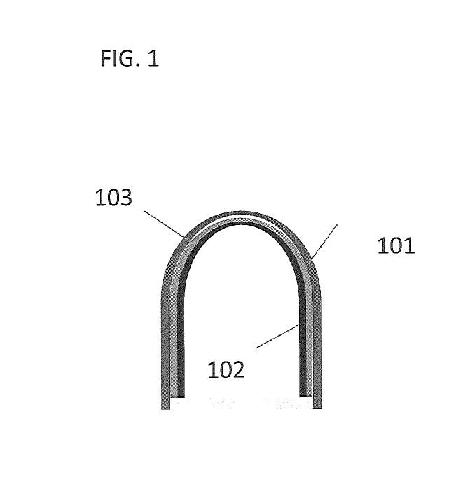

Generally, and with reference now to FIG. 1, initially, a radome 101 is provided. The radome 101 can be formed in different configurations. In one embodiment, the radome can be a monolithic wall of thickness n/4 wavelength. Such configuration may be of a low low polymer (LLP), composite or ceramic material. In another embodiment, 1 the radome 101 may have an A-sandwich configuration. Such a configuration may include a first layer of low loss polymer (LLP) through which electromagnetic radiation is transmittable, a second layer of LLP foam through which the electromagnetic radiation, having passed through the first layer, is transmittable, a third layer of LLP through which the electromagnetic radiation, having passed through the first and second layers, is transmittable and adhesive layers. Alternatively, the radome 101 may have a C-sandwich configuration in which the first, third and adhesive layers are provided generally as described above. The second layer may include a primary LLP foam layer, which is proximate to the first layer, a secondary LLP foam layer, which is proximate to the third layer, a mid-layer LLP layer, which is interposed between the primary and secondary LLP foam layers and additional adhesive layers. In another embodiment, the radome 101 has a multi-layer (ML) configuration. In that case, the radome 101 includes a first layer of LLP foam through which electromagnetic radiation is transmittable, a second layer of LLP through which the electromagnetic radiation, having passed through the first layer, is transmittable, a third layer of LLP through which the electromagnetic radiation, having passed through the first and second layers and, is transmittable, a fourth layer of LLP foam through which the electromagnetic radiation, having passed through the first, second and third layers, is transmittable and a fifth layer of LLP through which the electromagnetic radiation, having passed through the first, second, third and fourth layers, is transmittable. In such a case, adhesive layers may be interleaved between the first, second, third, fourth and fifth layers.

For each of the embodiments described above, the LLP on the exteriors of the radomes 101 act as skins for providing the radomes 101 with ruggedness and toughness even while being possibly deformable and compliant. Similarly, the LLP in the interiors of the radome 101 also provide the radome 101 with increased ruggedness and toughness without sacrificing deformability and compliance. Meanwhile, the LLP foam may be provided as compliant or deformable layer(s). In any case, while radomes in general are formed as rigid or semi-rigid structures, the radomes 101 described above may be characteristically deformable and compliant in at least some layers thereof. As such, impacts with foreign debris in particular can be absorbed and/or deflected. Thus, where foreign debris impacts might be catastrophic to a conventional radome, such incidents may not even lead to damage to the radomes 101 described above.

In accordance with additional aspects, it is to be understood that the various layers of LLP and LLP foam described above may be formed by way of rotational molding and/or other similar methods, such as injection molding, reaction injection molding, resin transfer molding, thermoforming, compression molding, wet and prepreg layup, rotational casting, casting, machining and three-dimensional printing.

Regardless of how formed, it shall be understood that the radome is formed using a first set of tools. Herein, the barrier layer may be formed using the same or similarly shaped tools. Consider for example using CVD to apply the layer. If that is done, a CVD machine that can accommodate the radome inside of it. However, a typical CVD machine cannot accommodate a radome that may be sized to for use in an aircraft or missile.

As illustrated, the radome 101 includes barrier layer 102 disposed on an inner surface thereof. It shall be understood, however, that the barrier layer 102 could be on an outer surface of the radome 101 in one embodiment. As illustrated, an optional adhesive layer 103 is illustrated as being between the barrier layer 102 and the radome 101. Of course, such adhesive may be part of the laying up processes or other formation processes described below and may be integrated into one or both of the radome 101 and barrier layer 102.

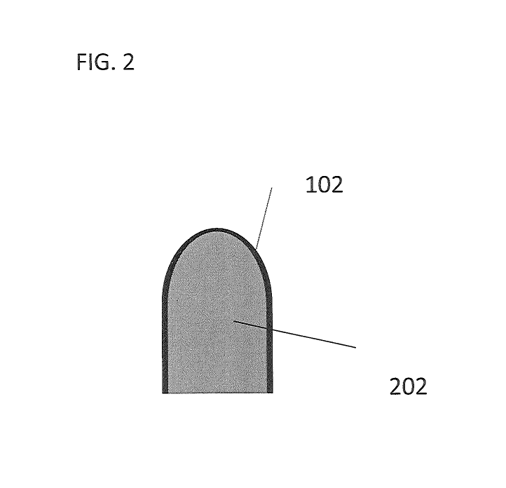

FIG. 2 illustrates the formation of a barrier layer 102 according to one embodiment. The barrier layer 102 of this embodiment is formed of Aclar or LCP. The layer 102 may be formed on a mold 202. The mold 202 may the same or a similarly sized mold used to form the radome. In one embodiment, the barrier layer 102 is initially a sheet that is thermoformed on the mold 202. As such, a net shaped film is produced that may then be inserted into and adhered to the radome. In another embodiment, the mold 202 may be a mold used in an injection molding machine and the layer 102 is formed over it by an injection molding process. Regardless of how formed, and with reference now to FIG. 1 as well, the layer 102 may be inserted into the radome and bonded it. Such bonding may be accomplished by adhesive 103 or may be thermoformed to the enclosure using a using vacuum, autoclave, thermoclave, or bladder press process.

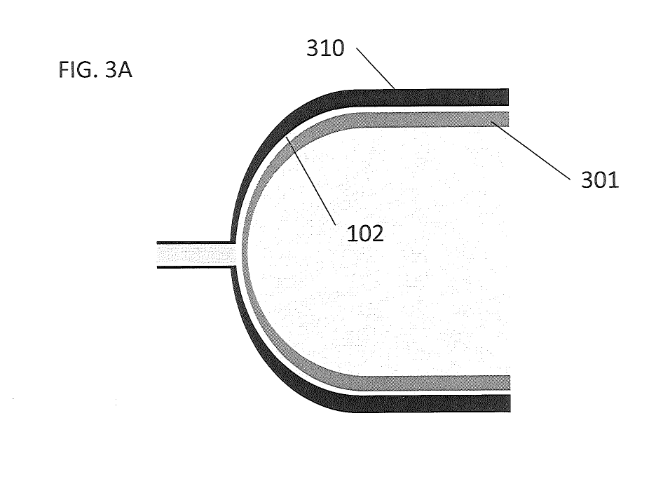

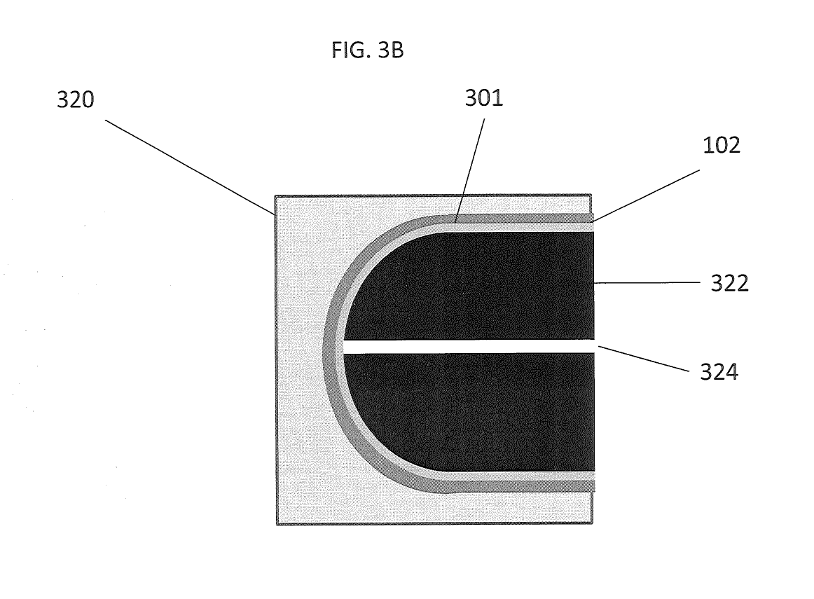

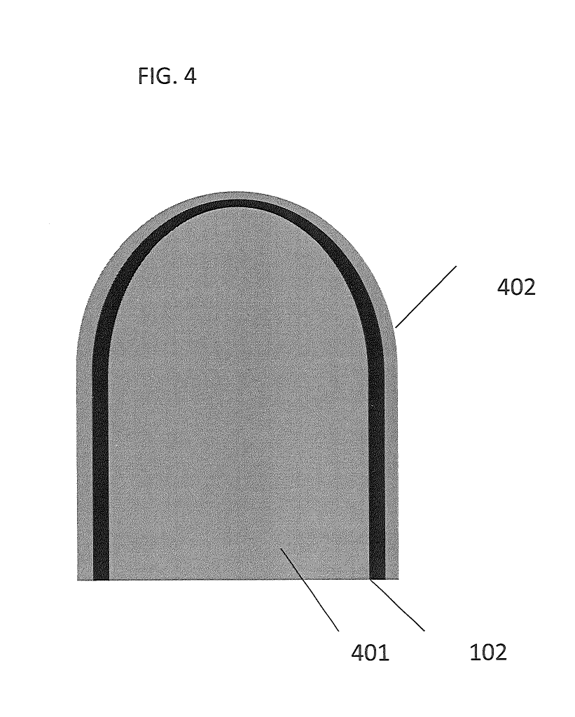

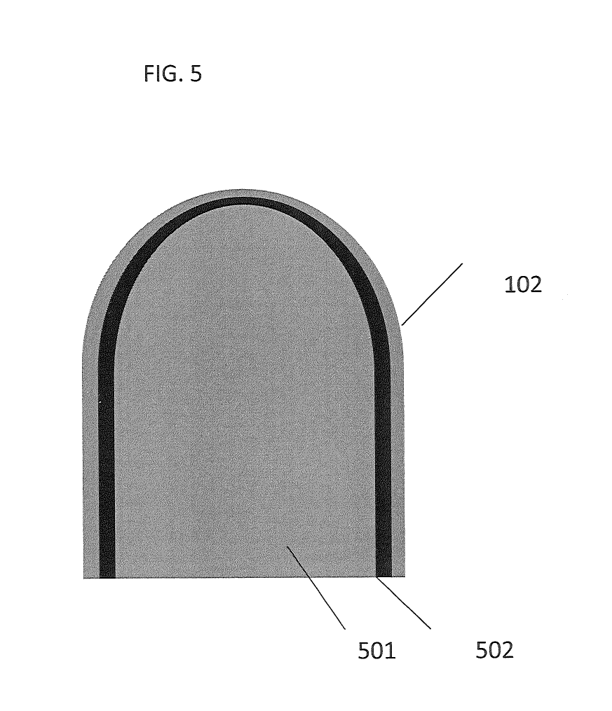

With reference now to FIG. 3A, in another embodiment, the layer 102 may be directly injected molded onto the radome 301. In particular, the radome 301 is first formed. The formed radome 301 may then form the mold into which the materials (as described above) may be injected molded onto. In FIG. 3, the outer portion of an injection molding machine is generally shown as element 310. The layer 102 may also be directly molding onto the inner surface of the radome 301 using tooling that consist of a female 320 tool to hold the radome 301 and male tool 322 with injection port 324 as shown in FIG. 3B.

In another embodiment, a tool 401 that defines the shape of the radome to be formed may be provided. Sheets of Aclar or LCP film may be molded onto the tool 401 by application, for example, thermoforming to form barrier layer 102. Then, a prepreg layer may be added to the surface and the layers (or other types) described above may be formed over it. In another embodiment, the prepeg may be omitted and the layers forming the radome 402 may utilize a wet layup and be formed directly on layer 102.

In another embodiment, a tool 501 that defines the shape of the radome to be formed may be provided. The radome 502 is formed on the tool 501. Sheets of Aclar or LCP film may be molded onto the tool 501 by application, for example, thermoforming to form barrier layer 102. Or course, a prepreg layer or other adhesive layer may be added to the surface of the radome 502 before the sheet is formed over it. This may allow the radome and the bond between it and the barrier layer 102 to be cured at the same time.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

While the embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A radome, comprising:
a first layer through which electromagnetic radiation is transmittable;
a moisture barrier layer connected to the second layer, the moisture barrier layer being formed of a single sheet of polychlorotrifluoroethene or a liquid crystal polymer.

2. The radome of claim 1, further comprising:
an adhesive layer interposed between the first layer and the moisture barrier layer.

3. The radome according to claim 1, wherein the first layer includes a low loss polymer (LLP) or an LLP foam.

4. A method of providing a moisture barrier to a radome, the method comprising:
forming the radome;
forming the moisture barrier layer as a single sheet of polychlorotrifluoroethene or a liquid crystal polymer; and
coupling the radome and the moisture barrier layer together.

5. The method of claim 4, wherein the radome is formed on a first tool and the moisture barrier is formed on the same first tool.

6. The method of claim 5, wherein the moisture barrier is thermoformed on the first tool.

7. The method of claim 5, wherein the moisture barrier is injected molded on the first tool.

8. The method of claim 5, wherein coupling includes adhering the radome to the moisture barrier with an adhesive.

9. The method of claim 4, wherein the moisture barrier layer is formed by injection molding onto an outer or inner surface of the radome.

10. The method of claim 4, wherein the moisture barrier layer is formed on a first tool.

11. The method of claim 10, wherein a prepreg layer is formed on the moisture barrier layer and the radome is formed over the prepreg layer.

12. The method of claim 10, wherein the radome is formed over the barrier layer by a wet layup process.

13. The method of claim 4, wherein the moisture barrier layer is formed over the radome by a thermoform process.
